(19) United States
(12) Patent Application Publication
(10) Pub. No.: US 2012/0060162 A1
(43) Pub. Date: Mar. 8, 2012

(54) SYSTEMS AND METHODS FOR PROVIDING A SENIOR LEADER APPROVAL PROCESS

(75) Inventors: Phillip E. Hunt, Kenmore, WA (US); James R. Stout, Timonium, MD (US); Breck Ruppelius, Montgomery, TX (US)

(73) Assignee: AVANADE HOLDINGS, LLC, Seattle, WA (US)

(21) Appl. No.: 13/223,003

(22) Filed: Aug. 31, 2011

Related U.S. Application Data
(60) Provisional application No. 61/378,916, filed on Aug. 31, 2010.

(51) Int. Cl. G06F 9/46

(52) U.S. Cl. 718/102

(57) ABSTRACT

Systems and methods of managing tasks within a customer relationship management system. A user with appropriate permissions who is assigned a task can create subtasks subordinate to the assigned task in order to delegate responsibility for completing the task. An owner of a task can seek input from other users by creating an approval route. A user interface is provided to display tasks assigned to a user in an approval route, and to allow a user to provide feedback on tasks assigned to them without having to sort through irrelevant information.

### CROSS-REFERENCE TO RELATED APPLICATION

This application claims the benefit of Provisional Application No. 61/378916, filed Aug. 31, 2010, the entire disclosure of which is hereby incorporated by reference herein.

### BACKGROUND

Generally described, extended relationship management (XRM) systems may be used to manage different types of relationships and information. For example, XRM systems may include customer relationship management (CRM) software to manage, automate, organize, and/or synchronize processes and data related to leads, sales, customer service, and technical support. CRM software may be used to improve marketing, dealings with clients, and sales in a business context, for example. In addition to managing relationships with customers, XRM systems may also be used to manage information or relationships with investors, partners, press, media, supply chain, human resources, and/or contacts.

One feature commonly included in XRM systems is task management. A task can be created in an XRM system and assigned to a user within the XRM system. This task indicates actions to be performed or verified by the user. Once the actions are performed or verified by the user, the user marks the task as completed within the XRM system. The task can be part of a larger workflow, where the completion of one task moves the workflow on to a new task.

In traditional XRM systems, it becomes exceedingly difficult to model increasingly complex business processes within the task framework. What are needed are an improved way to model complex tasks within an XRM system, and an improved way to assign responsibility for sub-tasks to users of the XRM system.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one embodiment, a computer-implemented method of creating an approval route is provided. An instruction to create an approval step in an approval route is received. The first approval step is created and stored in a task store. An action is associated with the approval step, and the action is stored in the task store. A result is associated with the action, and the result is also stored in the task store. A user is associated with the approval step, and this association is also stored in the task store.

In another embodiment, a server is provided. The server comprises a memory, one or more processors, and a computer-readable medium. The computer-readable medium has computer-executable instructions stored thereon, the instructions comprising instructions for causing the server to provide a web front end to access a task store. The web front end includes a task owner view and a task approval view. The task owner view includes one or more fields configured to display and to allow editing of information associated with a task. The task approval view includes one or more fields configured to display but not edit the information associated with the task.

In yet another embodiment, a computer-readable medium is provided, the computer-readable medium having computer-executable instructions stored thereon that, if executed by one or more processors of a computing device, cause the computing device to perform operations for managing an approval route for a task. The operations comprise receiving an instruction to create a first approval step in the approval route; creating the approval step and storing the approval step in a task store; associating an action with the approval step and storing the action in the task store; associating a result with the action, and storing the result in the task store; and associating a user with the approval step and storing the association in the task store.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a block diagram of one embodiment of an exemplary CRM system capable of managing tasks;

FIG. 2 illustrates one example embodiment of a traditional workflow as utilized within past CRM systems;

FIG. 3 illustrates an exemplary organizational chart by which an organization that uses embodiments of the present disclosure can be organized;

FIG. 4 illustrates one embodiment of a task tree in accordance with various aspects of the present disclosure;

FIG. 5 illustrates a portion of the task tree illustrated in FIG. 4, with additional details shown;

FIG. 6 illustrates one embodiment of an approval route action and a collection of approval route results according to various aspects of the present disclosure;

FIG. 7 is a block diagram illustrating an exemplary embodiment of an approval route according to various aspects of the present disclosure;

FIG. 8 illustrates one embodiment of a task owner view, according to various embodiments of the present disclosure;

FIG. 9 illustrates one embodiment of an approval view, according to various embodiments of the present disclosure; and

FIG. 10 illustrates another embodiment of an approval view, according to various embodiments of the present disclosure.

### DETAILED DESCRIPTION

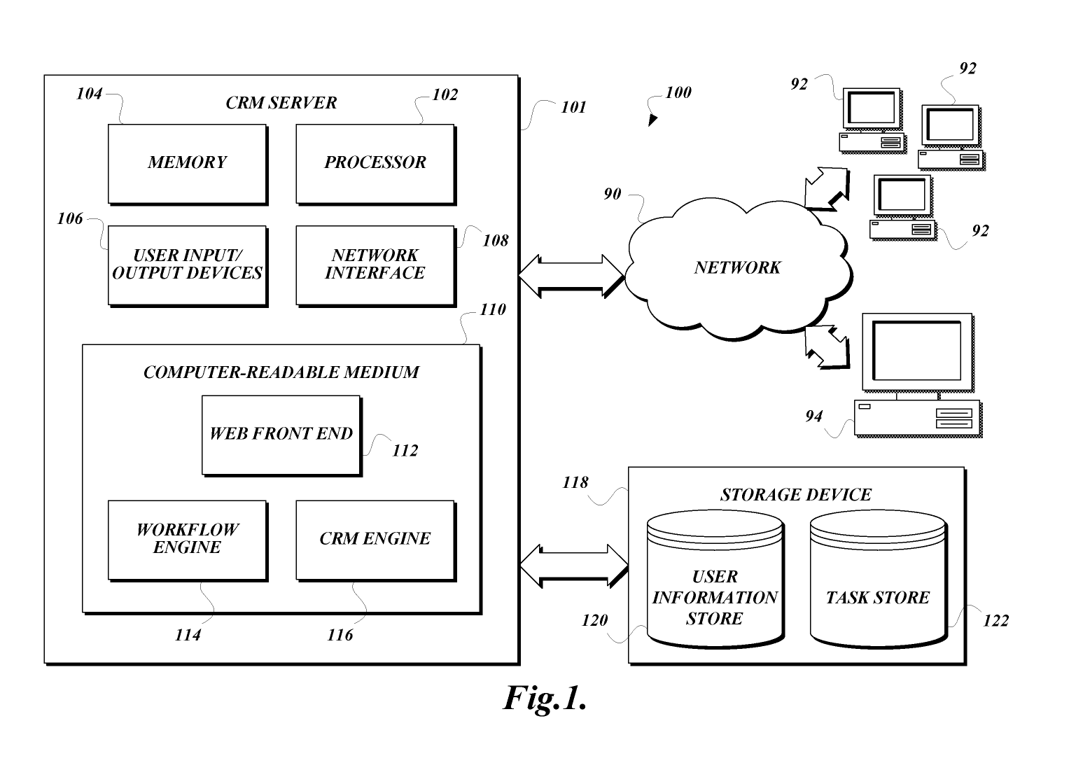

FIG. 1 illustrates a block diagram of one embodiment of an exemplary CRM system 100 capable of managing tasks. As shown, a management device 94 communicates with a CRM server 101 over a network 90. Various user devices 92 (representative of any number of user devices) also communicate with the CRM server 101. Communication within the system can take place over network 90 using sockets, ports, and other mechanisms known in the art. The communication can also be via wires, wireless technologies, cables, or other digital or analog techniques and devices to perform those techniques over a local area network (LAN), wide area network (WAN), the Internet, and the like. Management device 94, user devices 92, and other devices described herein can be a computing system, such as one or more computer servers, a peer-to-peer architecture, and the like. Management device 94, user devices 92, and other devices described herein can reside on physically separate machines, such as on separate personal computers. In other embodiments, these components can be located on the same physical machine. In addition, the illustrated system and devices can be configured to operate in local, remote, or cloud computing environments.

CRM server 101 includes a computer-readable medium 110 having computer-executable instructions stored thereon. In one embodiment, the computer-readable medium 110 is a magnetic storage medium, such as a hard drive, a floppy disk, and the like. In another embodiment, the computer-readable medium 110 is an optical storage medium, such as a DVD-ROM, CD-ROM, DVD-RW, CD-RW, and the like. In yet another embodiment, the computer-readable medium 110 is a solid state storage medium, such as a flash memory device and the like. In still another embodiment, the computer-readable medium 110 can be some other type of computer-readable storage device, including a data store accessed over a network.

In general, the word engine (used interchangeably with the word application or module), as used herein, refers to logic embodied in hardware or software instructions, which can be written in a programming language, such as JAVA™, PHP, Perl, HTML, CSS, JavaScript, VBScript, ASPX, Microsoft .NET™, and the like. An engine can be compiled into executable programs or written in interpreted programming languages. Software engines or applications may be callable from other engines or from themselves. Generally, the engines or applications described herein refer to logical modules that can be merged with other engines or applications, or can be divided into sub-engines. The engines or applications can be stored in any type of computer-readable medium or computer storage device and be stored on and executed by one or more general purpose computers, thus creating a special purpose computer configured to provide the engine or application.

The computer-executable instructions stored on the computer-readable medium 110 include instructions that, if executed by the processor 102, cause the CRM server 101 to provide a web front end 112, a workflow engine 114, and a CRM engine 116. As illustrated, the CRM engine 116 can include any XRM, CRM, or ERP system, such as Microsoft Dynamics CRM™ and the like. CRM engine 116 can utilize one or more accompanying XRM or CRM repositories (not shown) that can be stored in storage device 118. Among other actions, the workflow engine 114 performs actions relating to the creation and management of tasks within the CRM system 100, as discussed further below.

A user device 92 can include user applications that interface with the CRM server 101 via the web front end 112, the workflow engine 114, and the CRM engine 116. These user applications can include custom software that interfaces directly with the workflow engine 114 and the CRM engine 116. In a typical embodiment, the user application includes a standard Web browser which connects to a web application provided by the web front end 112. These user applications allow a user to interact with the CRM server 101 as described below. Management device 94 includes similar user applications, but which allow a user of the management device 94 to perform administrative tasks with respect to the CRM server 101, such as editing user permissions, backup schedules, and the like.

The CRM server 101, as well as the other devices shown and as with many standard computing devices, can include one or more processors 102, a memory 104 (such as random access memory (RAM)) that provides a high speed temporary data storage location for the one or more processors 102; one or more user input/output devices 106, such as a keyboard, mouse, monitor, and the like, to allow a user to interact directly with the CRM server 101; and a network interface 108 to enable the CRM server 101 to exchange data with other devices via a network 90. One example of a suitable computing device is a personal computer, and other examples include, but are not limited to, laptop computers, rack-mount computers, tablet computers, mobile devices, and the like.

The CRM server 101 can also be coupled to a storage device 118. The storage device 118 can be included within the same hardware enclosure as the rest of the components of the CRM server 101, or can be accessed by the CRM server 101 over a network. The storage device 118 can include one or more devices such as hard drives, solid state storage devices, optical drives, and the like. The storage device 118 stores one or more data repositories having a variety of structured or unstructured content, such as file systems or databases. In the illustrated embodiment, the storage device 118 stores a user information store 120 and a task store 122. The user information store 120 includes information identifying users of the CRM system 100, and stores user information such as user names, passwords, permissions to create, view, edit, delete, and take actions with respect to objects within the CRM system 100, and the like. The task store 122 includes information defining a plurality of tasks within the CRM system 100, as will be discussed further below.

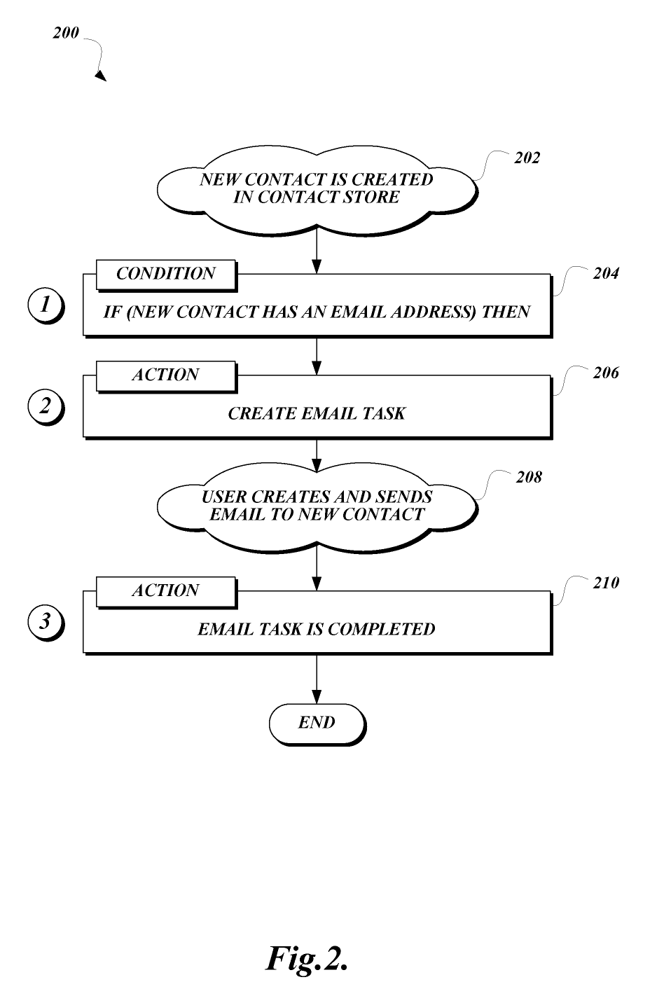

FIG. 2 illustrates one example embodiment of a traditional workflow 200 as was often utilized within past CRM systems. Occurrence of an event 202, such as a new contact being created in a contact store, causes the traditional workflow 200 to be launched. First, a workflow condition 204 is checked to determine whether the traditional workflow 200 should be executed against the newly created contact. In the illustrated case, the workflow condition 204 checks to see if the newly created contact has information denoting the contact's email address. If the workflow condition 204 determines that the condition has been fulfilled, the traditional workflow continues to a workflow action 206.

The workflow action 206 causes an email task to be created within, for example, the task store 122. The email task is a record within the task store 122 that indicates that an email should be sent to the newly created contact. The email task contains information identifying a user to whom the email task has been assigned, and can also contain further information about the email task, such as a proposed email template, a due date, and the like. Eventually, the user to whom the email task has been assigned creates and sends the email 208 as instructed by the email task. The user then accesses the CRM system to mark the email task as completed 210, and the traditional workflow 200 ends.

This traditional workflow 200 helps illuminate several shortcomings in how workflow processes have been represented, stored, and managed in the past. First, the workflow is limited to the steps, conditions, and actions that are proscriptively defined as part of the workflow. In essence, such a workflow can be represented as a flowchart with steps that are defined before the work is started, and in which users are assigned to sign off on each step of the flow chart during execution. This proscriptive definition of workflow processes leads to problems. For example, if the user to whom the email task is assigned wishes to delegate the task to a different user, or to split the task into multiple sub-tasks, the user is unable to do so without defining a new workflow that includes a delegation step or the desired sub-tasks. For increasingly complex processes, it becomes increasingly difficult, if not impossible, to proscriptively define each task used to complete the process before the overall process begins. Other problems with traditional workflows arise when individual tasks become increasingly detailed and complex, and require input from individuals who possess greater authority but who are nevertheless far removed from the details of the task. Embodiments of the present system allow greater flexibility in dynamically defining such tasks, and allowing a wider variety of actors to contribute to a task in a user-defined way.

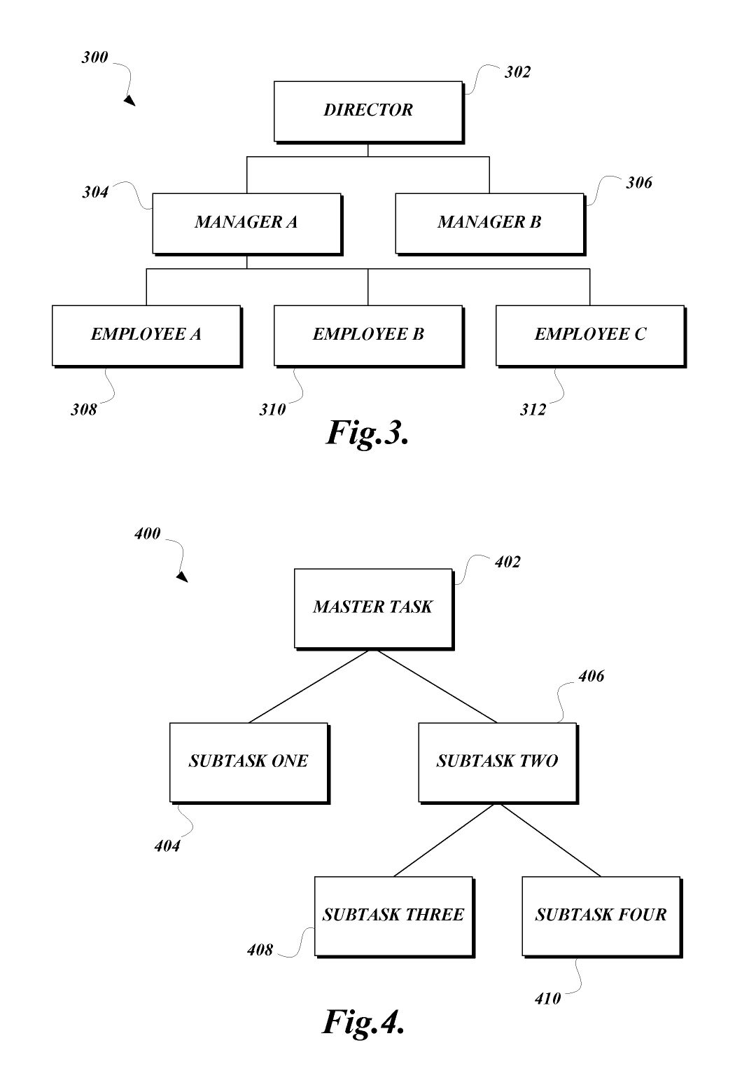

FIG. 3 illustrates an exemplary organizational chart 300 by which an organization that uses embodiments of the present disclosure can be organized. This organizational chart 300 is quite simple, but will suffice to demonstrate relationships that relate to the present disclosure. At the root of the organizational chart 300 is a director 302, who is the most powerful individual in the organization. The director 302 is ultimately responsible for the actions of the entire organization. Reporting to the director 302 are manager A 304 and manager B 306. Manager A 304 and manager B 306 perform their duties under the supervision and instruction of the director 302, and would likely refer to the director 302 as their boss. Manager A 304 is responsible for his own actions and the actions of his subordinates, but is not necessarily responsible for the actions of the subordinates of manager B 306.

The organizational chart 300 also illustrates three employees: employee A 308, employee B 310, and employee C 312. These employees 308, 310, 312 each report to manager A 304. As with the relationship between the director 302 and manager A 304, the employees 308, 310, 312 perform their duties under the direct supervision and instruction of manager A 304. The employees 308, 310, 312 also perform their duties under the indirect supervision of the director 302, as they are under the director 302 in the organizational chart 300. This organizational chart 300 is illustrative only; in other embodiments, the organizational chart 300 of another organization utilizing embodiments of the present disclosure can refer to the director 302 as a “president” and manager A 304 as a “vice-president,” can refer to each entity by the same name while retaining similar relationships of supervision and instruction, and the like.

To address the issues of complexity in traditional proscriptive workflow systems, embodiments of the present disclosure allow for the creation of task trees. In one embodiment of a task tree, a task is owned by a user. If the task is not easily described in a single record or performed by a single person, the user who owns the task may create new tasks related to the task in order to divide responsibility and tracking for the various parts of the task. In one embodiment, each subtask related to a given task is completed before completing the given task, thus allowing individual tracking and delegation of the subtasks while still ensuring that all subtasks of a given task are completed before completion of the given task. In one embodiment, a task can be owned by a group of users such as an entire organization, thus allowing any user within the group of users to take actions with respect to the task.

FIG. 4 illustrates one embodiment of a task tree 400 in accordance with various aspects of the present disclosure. A master task 402 is created by director 302. Director 302 can decide that the master task 402 is too complex to be tracked as a single task, and can create subtask one 404 and subtask two 406 to track the various portions of the master task 402. Each task can both be a subtask and a parent task of other tasks. For example, if subtask two 406 contains portion that are best delegated to outer individuals, the owner of subtask two 406 can create subtask three 408 and subtask four 410 as subtasks of subtask two 406.

In one embodiment, the task store 122 stores permission information relevant to each task along with the information defining each task. In one embodiment, the permission information can be used to determine which users are allowed to create root-level tasks. The permission information can also determine, for each existing task, which users are allowed to delete or edit the existing task, including creating subtasks under the existing task. Permissions can also be applied to the task store 122 as a whole for a user. For example, a given user can be assigned permission to view, edit, cancel, or delete any task in the task store 122. In one embodiment, the permission structure is similar to the structure of the organizational chart 300. That is, the director 302 can be granted the broadest permission to create, edit, delete, or create subtasks under any task in the task store 122. Manager A 304, along with the rest of the managers, can be given permission to create tasks and to view any task in the task store 122, but can also be limited to only being allowed to edit, delete, or create subtasks under tasks that manager A 304 himself created. Employee A 308 can be limited to only being allowed to view or create subtasks for individual tasks, as assigned by users with higher permissions. One of ordinary skill in the art will recognize that permission schemes other than this exemplary scheme are possible without departing from the scope of the present disclosure.

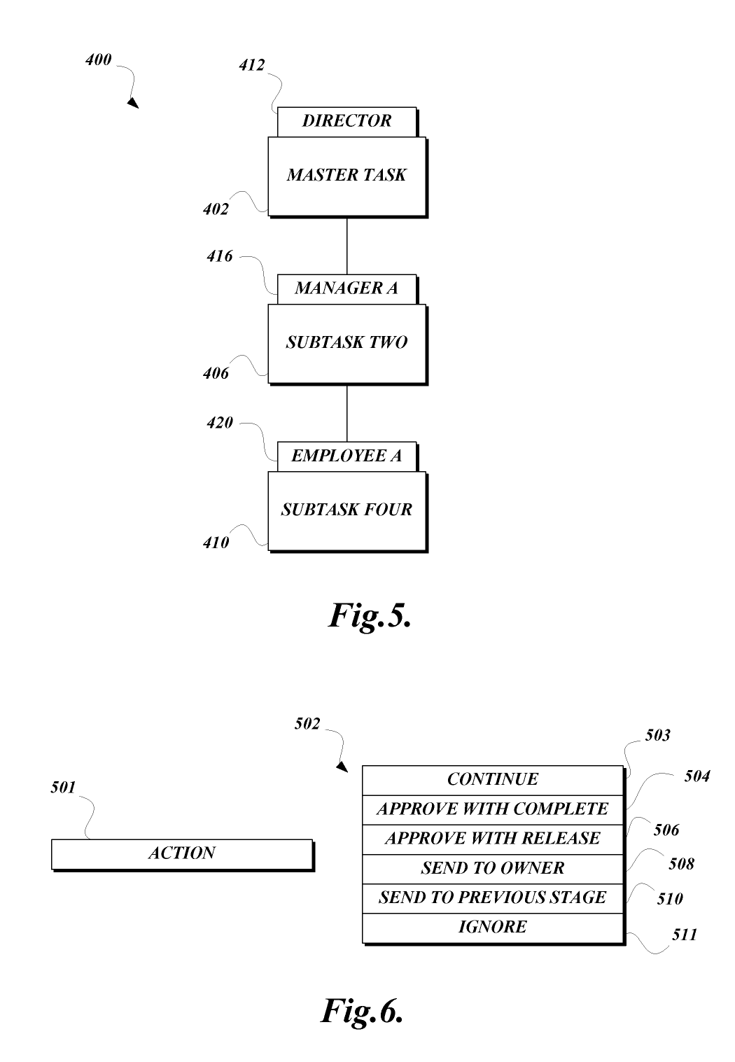

FIG. 5 illustrates one branch of the task tree 400 illustrated in FIG. 4, with additional details shown. Each task has an owner, who is responsible for completing the task. Director 302 is the master task owner 412, by virtue of being the user who initially created the master task 402. When director 302 created subtask two 406, director 302 assigned the task to manager A 304, thus making manager A 304 the subtask two owner 416. Likewise, when manager A created subtask four 410, manager A 304 assigned the task to employee A 308, thus making employee A 308 the subtask four owner 420.

In one embodiment, any task in a task tree can be assigned to any user of the CRM system 100. In another embodiment, task assignments are more limited. For example, a user at a given level of the organizational chart 300 is only permitted to assign tasks to users at their level of the organizational chart 300 or below. In another example, each user is permitted to be assigned only a single task in a given branch of a task tree. In such an embodiment, greater care must be taken in dividing tasks into subtasks, as each action within the overall task to be performed by a single user must be encompassed by a single task in the task tree.

In one embodiment, any task in a task tree can indicate that the task owner should perform work before completing the task. In another embodiment, only leaf elements of the task tree indicate that the task owner should perform work. This represents the common situation where managers, instead of performing work themselves, assign the work to their subordinates.

Before a user completes a task, the user may wish to obtain input or signoff from other users to show that the task has been reviewed. In one embodiment, the CRM system 100 provides functionality for creating an approval route associated with a task. The owner of the task creates the approval route, assigning a user to each action associated with the approval route. Each action is also associated with a result that determines the further progress of the approval route. FIG. 6 illustrates an approval route action 501 and a collection of approval route results 502. The approval route action 501 is configurable, and determines how a particular approval route step is represented within an associated user interface. The approval route results 502 define a set of options for how actuation of the approval route action 501 affects further processing of the approval route. Whereas the approval route action 501 is configurable for a given approval route step, the approval route result is chosen from the predetermined collection of approval route results 502. While in some embodiments, the collection of approval route results 502 can have a different set of results than those illustrated in FIG. 6, a result for those embodiments is still chosen from the embodiment's respective collection of results.

As stated above, each approval route action 501 is associated with an approval route result 502. Each approval route step can be associated with more than one action/result pair, and the action selected by the user determines the result of the approval route step. In one embodiment, each approval route step can be associated with no more than two action/result pairs. For a continue result 503, processing of the approval route simply continues. For an approve with complete result 504, any remaining steps in the approval route are closed automatically, and the underlying task is also completed. An owner of a task can use this type of approval route step to delegate responsibility for completing the task to another user without having to reassign the task. An ignore result 511 can be used to include a user in an approval route without requesting the user's feedback on the task. This will allow the user to review the task via an approval view as described below, and to receive notifications along with other users assigned to the approval route. However, whether or not the user assigned to a step associated with an ignore result 511 actuates the step has no effect on the processing of the approval route. An ignore result 511 can be associated with an approval route action 501 such as an “information only” action, or a “no review required” action.

One particular type of task is used to track a message to be sent out. For example, a master task can be created to respond to a request for proposals. Part of this task involves sending a message in response to the request for proposal. For an approve with release result 506, the approval route continues, but the message associated with the underlying task is sent.

For a send to owner result 508, further processing on the approval route is stopped. Instead, a notification is transmitted to the owner of the task along with comments from the reviewing user, which could, for example, indicate changes that the reviewing user wants made before approving the task. As explained further below, steps in an approval route can be grouped into stages. For a send to previous stage result 510, any results submitted in a previous stage are cleared, and notifications for users assigned to steps in the previous stage are resent to re-execute the previous steps.

In one embodiment, the workflow engine 114 is responsible for managing the execution of the approval route. Each time an approval step is completed, the workflow engine 114 records a flag associated with the action in the task store 122, along with any comments submitted by the actuating user. This stored information can then be viewed by the owner of the task, and by other users assigned to the approval route. As described further below, the workflow engine 114 determines after each step is completed whether the approval route as a whole has been completed, whether notifications must be sent, and the like.

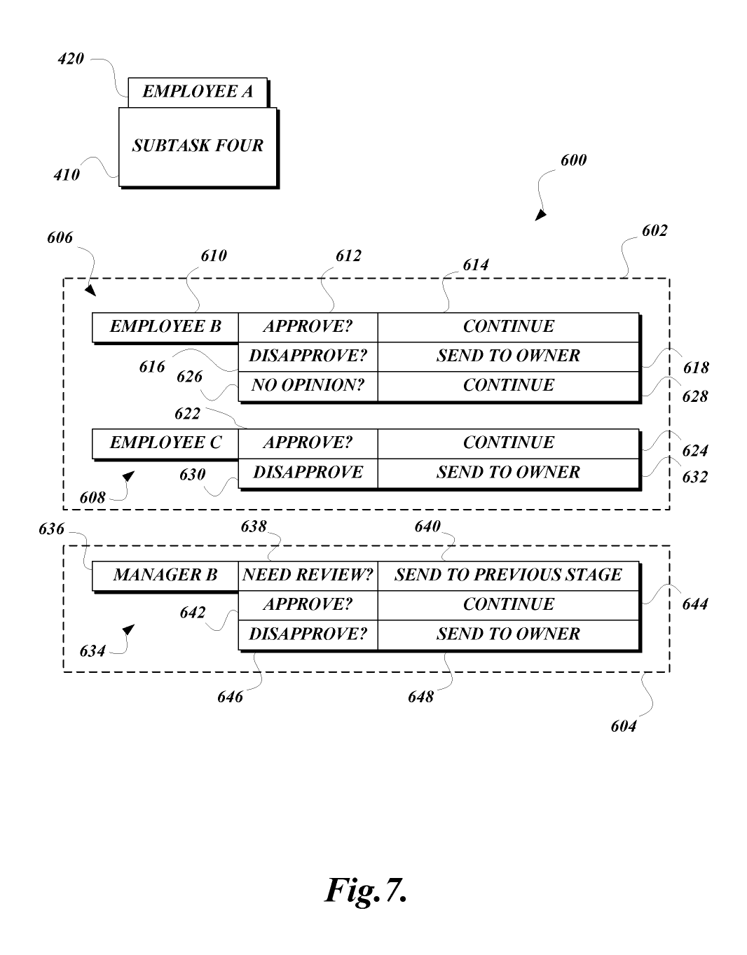

FIG. 7 illustrates an exemplary embodiment of an approval route 600. This approval route 600 is created, for example, by employee A 420 to receive feedback from other users before completing subtask four 410. The approval route 600 is split into two stages, a first approval stage 602 and a second approval stage 604. The approval stages are performed in series, while the approval steps in each stage are performed in parallel. At the beginning of a given approval stage, the workflow engine 114 sends a notification to the users assigned to approval steps within the approval stage that the task is awaiting their review. These users can review the task and submit their approvals at the same time, and need not wait for one another. Once the workflow engine 114 detects that all of the approval steps in an approval stage have been approved, the workflow engine 114 repeats the process with the next approval stage.

The first approval stage 602 includes a first approval step 606 and a second approval step 608. The user assigned as the approval step actuator 610 for the first approval step 606 is employee B 310. Employee B 310 can choose between several approval step actions. The “approve?” approval step action 612 is associated with a continue result 614. The “disapprove?” approval step action 616 is associated with a send to owner result 618. The “no opinion?” approval step action 626 is also associated with a continue result 628. Though the “approve?” approval step action 612 and the “no opinion?” approval step action 626 will cause the workflow engine 114 to record different approval actions in the task store 122, both will have the same affect on subsequent processing of the approval route since they are both associated with a continue result.

While the workflow engine 114 has prompted employee B 310 to review subtask four 410 due to the first approval step 606, the workflow engine 114 has also prompted employee C 312 to review subtask four 410 due to the second approval step 608. The second approval step 608 assigns employee C 312 as the approval step actuator 620. Employee C 312 can choose between an “approve?” approval step action 622 and a “disapprove?” approval step action 630. Similar to the first approval step 606, the “approve?” approval step action 622 is associated with a continue result 624, and the “disapprove?” approval step action 630 is associated with a send to owner result 632.

Once the workflow engine 114 detects that both the first approval step 606 and the second approval step 608 have been completed with a continue result, the workflow engine 114 advances the approval route to the second approval stage 604 by sending a notification to the users assigned approval steps in the second approval stage 604. In the illustrated example, this would include sending a notification to manager B 306, who is assigned as the approval step actuator 636 of the third approval step 634. Similar to the steps above, the third approval step 634 includes an “approve?” approval step action 642 associated with a continue result 644, and a “disapprove?” approval step action 646 associated with a send to owner result 648. The third approval step 634 also includes a “need review?” approval step action 638. Actuation of this approval step action 638 can indicate that manager B 306 has determined that the review performed in the previous stage was not adequate, or that the reviewers of the previous stage should take into account additional information. The “need review?” approval step action 638 is associated with a send to previous stage result 640. Once this result is submitted, the workflow engine 114 clears the results of the first approval stage 604, and re-sends the notifications to the users assigned to the approval steps within the first approval stage 604.

The third approval step 634 is an example of tasking up. Tasking up refers to a situation where a lower member of the organizational chart (such as employee A 308) assigns a higher member of the organizational chart (such as manager B 306) to an approval route for a task that the lower member of the organizational chart owns. In the approval route 600, employee A 308 has assigned manager B 306 to the third approval step 634 for the approval route 600 associated with subtask four 410. This allows lower-level employees to request and receive input from higher-level employees on tasks without requiring the lower-level employees to assign responsibility or ownership for the task to the higher-level employees, which would imply that the lower-level employees are allowed to direct the activities of the higher-level employees. In one embodiment, this can be particularly useful in the case of an approve with complete result 504 or an approve with release result 506, as it allows the lower-level employee to delegate completion or release of a task to a higher-level employee who is ultimately responsible for the finished product.

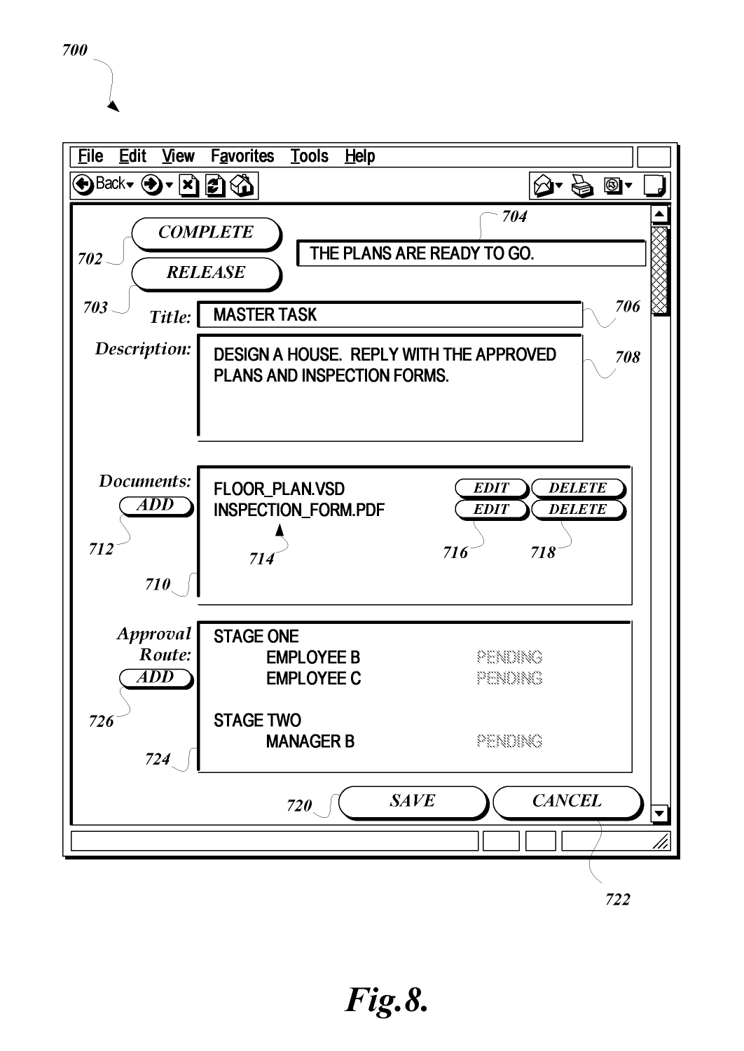

FIG. 8 illustrates one embodiment of a task owner view 700, as would be displayed to the owner of a task to edit the task. The task owner view 700 is separate from views used during execution of an approval route, which are described further below. Any type of task can be tracked with the CRM system 100. The illustrated task is related to an exemplary process of building a house, for sake of discussion. Such a complex task would best be split into many subtasks, and is an example of a type of task for which embodiments of the present disclosure are particularly appropriate. As illustrated, the task owner view 700 is a web application provided, for example, by the web front end 112. In other embodiments, the task owner view 700 can be part of a stand-alone application that communicates directly with the workflow engine 114 and the CRM engine 116. The task owner view 700 can also be provided as a plug-in or other type of extension to an existing stand-alone application.

The task owner view 700 allows the task owner to edit every aspect of the task. This includes allowing the task owner to release the message associated with the task, or to complete the task once it is finished. A complete button 702 is provided to allow the task owner to complete the task, and a release button 703 is provided to allow the task owner to release the message associated with the task. A comment field 704 accepts input from the task owner to be included when the task owner completes the task. A title field 706 and a description field 708 contain information concerning the task, and can be edited by the task owner. A document display 710 lists a set of documents associated with the task. A document add button 712 causes a dialog to be displayed that allows the task owner to add documents to the document display 710. The document name 714 of each document appears in the document display 710, along with an edit document button 718 and a delete document button 718. After changes are made to the task in the task owner view 700, the task owner can save the changes by clicking a save changes button 720, or can discard the changes by clicking a cancel changes button 722. For purposes of example, the task owner view 700 is illustrated with exemplary data relevant to the previously illustrated master task 402.

The task owner view 700 also includes an approval route display 724, which is configured to display the status of approval routes currently or previously executing on the associated task. The task owner can create and launch a new approval route by clicking the approval route add button 726. A dialog is then displayed that allows the task owner to specify approval stages, select approval steps for each approval stage, and assign users to each approval step.

Though not illustrated, the task owner view 700 can also allow the task owner to perform other actions with relation to the task. For example, the task owner view 700 can allow the task owner to add subtasks to the task, as long as no approval route is currently active. As another example, the task owner view 700 can also allow the task owner to edit a message associated with the task, which is sent when the task is released.

One problem that arises for users who are asked to approve tasks that are owned by other users is that they are not as familiar with the tasks as are the task owners. Since the reviewing users are typically removed from the details of the tasks, being presented with too much information regarding the tasks can confuse the reviewing user, and make it more difficult for them to approve or disapprove the task. Also, high-level employees can have greatly elevated permissions within the CRM system 100 than are strictly necessary for review and approval of a given task. Offering high-level employees the opportunity to manipulate tasks for which they have permission to do so but in cases where only approval is required can also be confusing, and can lead to high-level employees accidentally editing tasks in an inappropriate manner.

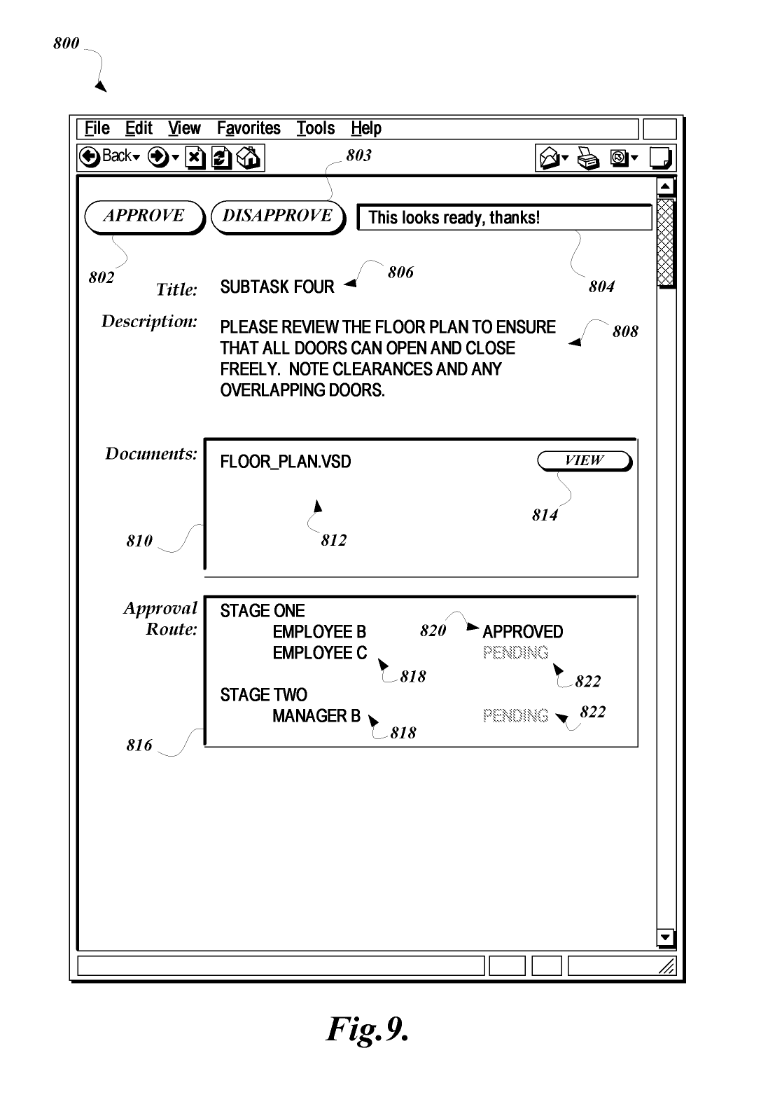

To address this problem, one embodiment of the present disclosure provides a simplified user interface separate from the task owner view that provides a limited amount of information relevant to approval of a task. FIG. 9 illustrates one embodiment of an approval view 800 associated with the second approval step 608 discussed above. The illustrated approval view 800 is shown as it would be displayed to the employee C 312 when approving subtask four 410. The approval view 800 simplifies the interface for employee C 312 compared to the task owner view 700, so that employee C 312 can only interact with subtask four 410 in ways relevant to the second approval step 608. The approval view 800 provides an approve actuation button 802 and a disapprove actuation button 804, along with a comment field 804 that allows employee C 312 to include a comment with the actuation of the approval step. In one embodiment, an additional field is included (not shown) that allows employee C 312 to directly edit a message associated with the task that is to be sent once the task is released. A title field 806 and a description field 808 are also present, but in contrast to the task owner view 700, the approval view 800 does not allow the viewing user to edit the text in these fields. Similarly, the approval view 800 includes a document display 810, but instead of allowing the viewer to add, edit, and delete documents, the document display 810 only allows the viewing user to see the document name 812 and to view the document by clicking a view document button 814 for each document associated with the task. The approval view 800 also includes an approval route status field 816, which displays each of the approval route users 818 assigned to the approval route. The approval route status field 816 shows the user any previous approval results 820, and the status of any pending approval results 822, so that the user can see what input has already been provided by other users.

Though a sample approval view 800 was illustrated for the second approval step 608, other approval steps would have similar approval views appropriate for the particular configuration of the approval step. For example, the first approval step 608 would have an approval view with three actuation buttons, since the first approval step 608 provided three possible actions. Also, since the actions are configurable, the text provided on the actuation buttons will change to match the action.

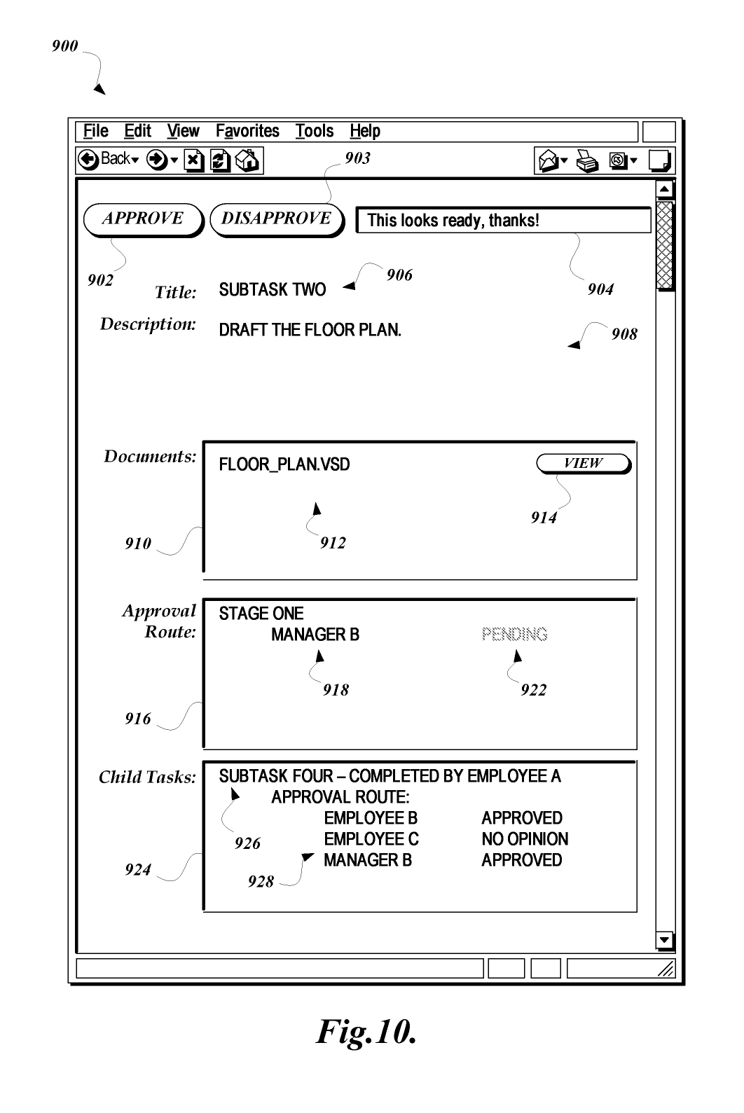

FIG. 10 illustrates an approval view 900 associated with subtask two 406, as viewed by manager B 306 as part of a simple approval route. This approval route is associated with subtask two 406, and is separate from the approval route 600 illustrated and discussed above. The approval view 900 shares many of the same features of approval view 800, including actuation buttons 902, 903, a comment field 804, a title field 806, a description field 808, a document display 910 having a document name 912 and a view document button 914, and an approval route status field 916, showing only one approval route user 918 and a pending approval result 922. As discussed above, subtask two 406 is a parent task to subtask four 410. Hence, the approval view 900 also includes a child task status display 924. The child task status display 924 includes the subtask result 926, and also includes the subtask approval route result 928. This allows the reviewing user to note the progress of child tasks before providing approval of the current task.

In one embodiment, permissions for viewing tasks associated with an approval route are inherited from the permissions on the tasks themselves. For instance, if a user does not have permission to view a given task, the user will likewise not have permission to view the approval view 800 if they are assigned to an approval route for the task. In another embodiment, the CRM system 100, including the workflow engine 114, the task store 122, and the web front end 112, each bypass the permissions relevant to a given task when a user is assigned to an approval route for a task, so that the user can at least use the approval view 800 to review the task and to access data and documents associated with the task.

In one embodiment, the web front end 112 can provide a summary view (not pictured) which allows a user to view all tasks and approval routes associated with the user. This view allows the user to quickly examine all of the tasks that are awaiting the user's input, and can therefore allow the user to keep abreast of their workload.

Though some language in the above description may imply that actions and steps in embodiments of the present disclosure are performed by humans, in at least one embodiment each step or action described above is performed by a particular computing device configured to perform the step or action, or is mediated by a particular computing device configured to enable the step or action.

While the preferred embodiment of the invention has been illustrated and described, it will be appreciated that various changes can be made therein without departing from the spirit and scope of the invention. For example, the task management hardware and methods described herein can be used as a standalone system apart from any CRM or XRM system, or in combination with other similar systems.

The embodiments of the invention in which an exclusive property or privilege is claimed are defined as follows:

1. A computer-implemented method of creating an approval route, the method comprising:
receiving, by a computing device, an instruction to create an approval step in an approval route;
creating, by the computing device, the first approval step and storing the approval step in a task store;
associating an action with the approval step and storing the action in the task store;
associating a result with the action, and storing the result in the task store; and
associating a user with the approval step, and storing the association in the task store.

2. The computer-implemented method of claim 1, wherein the result is selected from a group consisting of a continue result, an approve with complete result, an approve with release result, a send to owner result, a send to previous stage result, and an ignore result.

3. The computer-implemented method of claim 1, wherein the approval route is associated with a task.

4. The computer-implemented method of claim 3, wherein the user associated with the approval step is a user other than a user that owns the task.

5. The computer-implemented method of claim 1, further comprising:
receiving an instruction to create a first stage and a second stage in the approval route; and
creating and storing the first stage and the second stage in the task store.

6. The computer-implemented method of claim 5, further comprising:
associating a first set of approval steps with the first stage; and
associating a second set of approval steps with the second stage.

7. The computer-implemented method of claim 6, further comprising:
transmitting a notification to users associated with each approval step of the first set of approval steps;
receiving an indication that each of the approval steps of the first set of approval steps has been completed; and
transmitting a notification to users associated with each approval step of the second set of approval steps.

8. A server, comprising:
a memory;
one or more processors; and
a computer-readable medium having computer-executable instructions stored thereon, the instructions comprising instructions that, if executed by a processor of the server, cause the server to provide a web front end to access a task store, the web front end including:
a task owner view that includes one or more fields configured to display and to allow editing of information associated with a task; and
a task approval view that includes one or more fields configured to display but not edit the information associated with the task.

9. The server of claim 8, wherein the web front end is configured to display the task approval view to an approving user associated with an approval route for the task in a case where the approving user has sufficient permissions to access the task owner view.

10. The server of claim 8, wherein the web front end further includes a task summary view that includes a list of each task with which a requesting user owns and a list of each approval step associated with the requesting user.

11. The server of claim 8, wherein the task approval view further includes one or more actuation buttons.

12. The server of claim 8, wherein the web front end is configured to automatically determine whether to display the task owner view or the task approval view for a requested task to a requesting user based on whether the requesting user is associated with an approval route for the requested task.

13. The server of claim 8, wherein the web front end is configured to determine whether to display the task owner view or the task approval view for a requested task to a requesting user based on an indication of a desired view submitted by the requesting user.

14. The server of claim 8, wherein the web front end is configured to display the task approval view for a requested task to a requesting user when the requesting user is associated with an approval route for the task and the requesting user does not otherwise have permission to access the requested task.

15. A computer-readable medium having computer-executable instructions stored thereon that, if executed by one or more processors of a computing device, cause the computing device to perform actions for managing an approval route for a task, the actions comprising:
receiving, by the computing device, an instruction to create a first approval step in the approval route;
creating, by the computing device, the approval step and storing the approval step in a task store;
associating an action with the approval step and storing the action in the task store;
associating a result with the action, and storing the result in the task store; and
associating a user with the approval step, and storing the association in the task store.

16. The computer-readable medium of claim 15, wherein the result is selected from a group consisting of a continue result, an approve with complete result, an approve with release result, a send to owner result, a send to previous stage result, and an ignore result.

17. The computer-readable medium of claim 15, wherein the user associated with the approval step is a user other than a user that owns the task.

18. The computer-readable medium of claim 17, wherein the result is an approve with complete result, and wherein the actions further comprise:
receiving an actuation command associated with the approve with complete result from the associated user; and
automatically completing the task.

19. The computer-readable medium of claim 18, wherein the actions further comprise:
receiving an instruction to create a first stage and a second stage in the approval route; and
creating and storing the first stage and the second stage in the task store.

20. The computer-readable medium of claim 15, wherein the actions further comprise:
associating a first set of approval steps with the first stage; and
associating a second set of approval steps with the second stage.
